(19) United States
(12) Patent Application Publication
(10) Pub. No.: US 2023/0131394 A1
(43) Pub. Date: Apr. 27, 2023

(54) ESTABLISHMENT OF A TELECOMMUNICATIONS SERVICE

(71) Applicant: BRITISH TELECOMMUNICATIONS PUBLIC LIMITED COMPANY, London (GB)

(72) Inventors: Andrew CORSTON-PETRIE, London (GB); Ruth BROWN, London (GB); Jonathan HART, London (GB)

(21) Appl. No.: 17/914,137

(22) PCT Filed: Mar. 19, 2021
(86) PCT No.: PCT/EP2021/057160

§ 371 Date: Sep. 23, 2022

(30) Foreign Application Priority Data
Mar. 26, 2020 (GB) 2004406.1

(51) Int. Cl. H04L 67/63; H04L 67/141; H04L 41/342; H04L 45/02

(52) U.S. Cl. CPC H04L 67/63; H04L 67/141; H04L 41/342; H04L 45/04

(57) ABSTRACT

A method of establishing a telecommunications service between a client and a server. The method comprises receiving a request at a first domain for the telecommunications service and providing, by the first domain, a first function for establishing part of the telecommunications service. A process is repeatedly performed until a path is established between the client and the server via a plurality of domains comprising the first domain. The process comprises a domain identifying and instructing a subsequent domain to provide a further function for establishing the telecommunications service, and using the subsequent domain as the domain for a subsequent iteration of the process. The telecommunications service is established between the client and server via the plurality of domains

### FIELD OF INVENTION

The present invention relates to establishment of a telecommunications service, and in particular to establishment of a telecommunications service between a client and a server via a plurality of domains.

### BACKGROUND

It is known to use an orchestrator to coordinate routing from and to User Equipment (UE) to provide a service in a telecommunications network that traverses a plurality of domains. The orchestrator maintains domain knowledge for all of the domains so that the orchestrator can manage the provision of the service across the domains.

The amount of information gathered by the orchestrator increases as the number of domains used to provide the service increases, making this approach challenging to scale. Furthermore, managing each of the domains to provide the service is complex. It is therefore demanding for the orchestrator to ensure the maintenance of the performance and quality of the provided service.

It is an aim of the present invention to at least alleviate some of the aforementioned problems.

### STATEMENTS OF INVENTION

According to a first aspect of the present invention, there is provided a method of establishing a telecommunications service between a client and a server, the method comprising: receiving a request at a first domain for the telecommunications service; providing, by the first domain, a first function for establishing part of the telecommunications service; repeatedly performing a process until a path is established between the client and the server via a plurality of domains comprising the first domain, the process comprising: a domain identifying and instructing a subsequent domain to provide a further function for establishing the telecommunications service; and using the subsequent domain as the domain for a subsequent iteration of the process; and establishing the telecommunications service between the client and server via the plurality of domains.

In some examples, the first function is for creating a subslice of a given network slice within the first domain, and the further function is for creating a further subslice of the given network slice within the subsequent domain. In some examples, the plurality of domains comprises the first domain, a second domain and a third domain, the second domain having been identified and instructed by the first domain to provide the further function, and the third domain having been identified and instructed by the second domain to provide the further function. The second domain may communicate to the first domain that the third domain has been identified and instructed by the second domain to provide the further function. In some examples, each respective domain in the plurality of domains comprises an orchestrator, and the identifying and instructing is performed by each orchestrator. In some examples, at least one performance of the process comprises the domain identifying and instructing a plurality of subsequent domains to provide the further function. In some examples, the domain identifying the subsequent domain comprises the domain identifying a neighbouring domain as the subsequent domain. In some examples, the method comprises: a first one of the plurality of domains monitoring a status of a second one of the plurality of domains that neighbours the first one of the plurality of domains; based on the status of the second one of the plurality of domains, determining that the second one of the plurality of domains is unsuitable for providing the telecommunications service; the first one of the plurality of domains identifying an alternative domain to the second one of the plurality of domains for providing the telecommunications service; and updating the plurality of domains to include the alternative domain instead of the second one of the plurality of domains.

The first one of the plurality of domains may monitor a status of at least one further domain that neighbours the first one of the plurality of domains, and identifying the alternative domain may comprise identifying the alternative domain from the at least one further domain based on the status of the alternative domain. In some examples, the method comprises: each respective domain of the plurality of domains monitoring a status of at least one neighbouring domain of the plurality of domains; and based on the status of at least one of the plurality of domains, updating the plurality of domains to include a different at least one domain instead of the at least one of the plurality of domains. The status may indicate that the at least one of the plurality of domains is unavailable and/or that a capacity of the at least one of the plurality of domains fails to satisfy a capacity condition. In some examples, the process comprises the domain obtaining characteristic data from the subsequent domain, the characteristic data representative of at least one characteristic of the subsequent domain, wherein the identifying the subsequent domain is based at least partly on the characteristic data. The characteristic data may be representative of an availability of the subsequent domain, a location of the subsequent domain, a capacity of the subsequent domain, a connectivity of the subsequent domain and/or a performance of the subsequent domain. In some examples, a given domain of the plurality of domains is in the form of: a network associated with a network operator; a portion of a network; and/or a logical restriction for providing a service. In some examples, the client comprises User Equipment (UE).

According to a second aspect of the present invention, there is provided a telecommunications network for establishing a telecommunications service between a client and a server, the telecommunications network comprising at least one processor configured to: receive a request at a first domain of the telecommunications network for the telecommunications service; provide, by the first domain, a first function for establishing part of the telecommunications service; repeatedly perform a process until a path is established between the client and the server via a plurality of domains comprising the first domain, the process comprising: a domain identifying and instructing a subsequent domain to provide a further function for establishing the telecommunications service; and using the subsequent domain as the domain for a subsequent iteration of the process; and establish the telecommunications service between the client and server via the plurality of domains.

In some examples, each respective domain in the plurality of domains comprises an orchestrator comprising at least one of the at least one processor, and the identifying and instructing is performed by each orchestrator. In some examples, each respective domain in the plurality of domains comprises an application programming interface to transmit and/or receive instructions to provide the further function. In some examples, each respective domain in the plurality of domains comprises storage for storing characteristic data representative of at least one characteristic of at least one neighbouring domain of the plurality of domains.

According to a third aspect of the present invention, there is provided a method of establishing a telecommunications service between a client and a server, the method comprising: receiving a request at a first domain for the telecommunications service; providing, by the first domain, a first function for establishing the telecommunications service; the first domain identifying and instructing a second domain to provide a second function for establishing the telecommunications service; the second domain identifying and instructing a third domain to provide a third function for establishing the telecommunications service; and establishing a path between the client and the server via the plurality of domains, the plurality of domains comprising the first domain, the second domain and the third domain.

In some examples, the method comprises the first domain identifying and instructing the second domain to identify and instruct the third domain to provide the third function. In some examples, the first domain identifies and instructs the second domain to identify and instruct the third domain without the first domain directly communicating with the third domain. In some examples, the second domain identifying and instructing the third domain to provide the third function comprises the second domain identifying and instructing a plurality of domains, comprising the third domain, to provide the third function. In some examples, the third domain is adjacent to the second domain and the method comprises: the second domain monitoring a status of the third domain; based on the status of the third domain, determining that the third domain is unsuitable for providing the telecommunications service; identifying an alternative domain to the third domain for providing the telecommunications service; and replacing the third domain with the alternative domain in the path.

According to a fourth aspect of the present invention, there is provided a computer-readable medium storing thereon a program for carrying out the method of any examples in accordance with the first or third aspects.

The invention includes any novel aspects described and/or illustrated herein. The invention also extends to methods and/or apparatus substantially as herein described and/or as illustrated with reference to the accompanying drawings. The invention is also provided as a computer program and/or a computer program product for carrying out any of the methods described herein and/or for embodying any of the apparatus features described herein, a computer-readable medium storing thereon a program for carrying out any of the methods and/or for embodying any of the apparatus features described herein. Features described as being implemented in hardware may alternatively be implemented in software, and vice versa.

The invention also provides a method of transmitting a signal, and a computer product having an operating system that supports a computer program for performing any of the methods described herein and/or for embodying any of the apparatus features described herein. Any apparatus feature may also be provided as a corresponding step of a method, and vice versa. As used herein, means plus function features may alternatively be expressed in terms of their corresponding structure, for example as a suitably-programmed processor and/or as suitably configured circuitry. Any feature in one aspect of the invention may be applied, in any appropriate combination, to other aspects of the invention. Any, some and/or all features in one aspect can be applied to any, some and/or all features in any other aspect, in any appropriate combination. Particular combinations of the various features described and defined in any aspects of the invention can be implemented and/or supplied and/or used independently. As used throughout, the word ‘or’ can be interpreted in the exclusive and/or inclusive sense, unless otherwise specified. The invention extends at least to methods of establishing a telecommunications service, a telecommunications network and a computer-readable medium substantially as described herein and/or substantially as illustrated with reference to the accompanying drawings. The present invention is now described, purely by way of example, with reference to the accompanying diagrammatic drawings, in which:

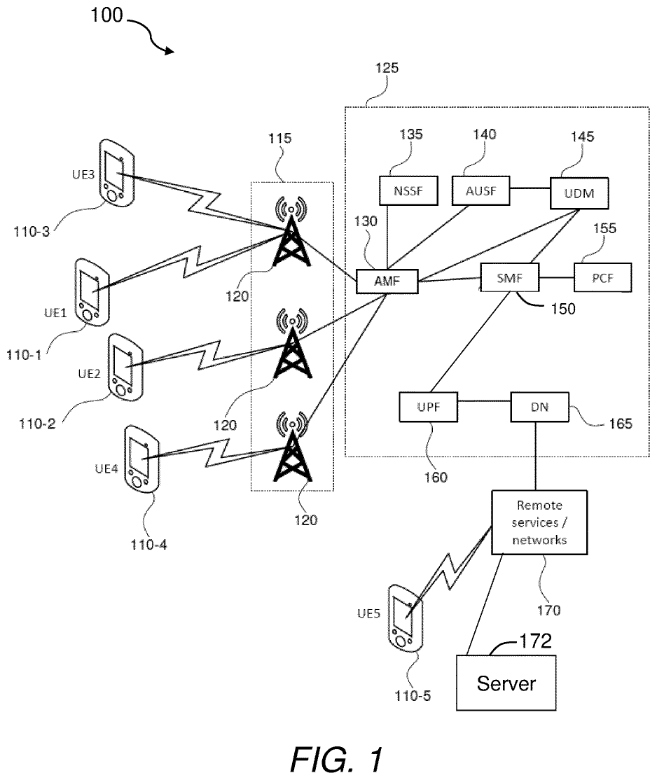

FIG. 1 is a schematic diagram showing a telecommunications network;

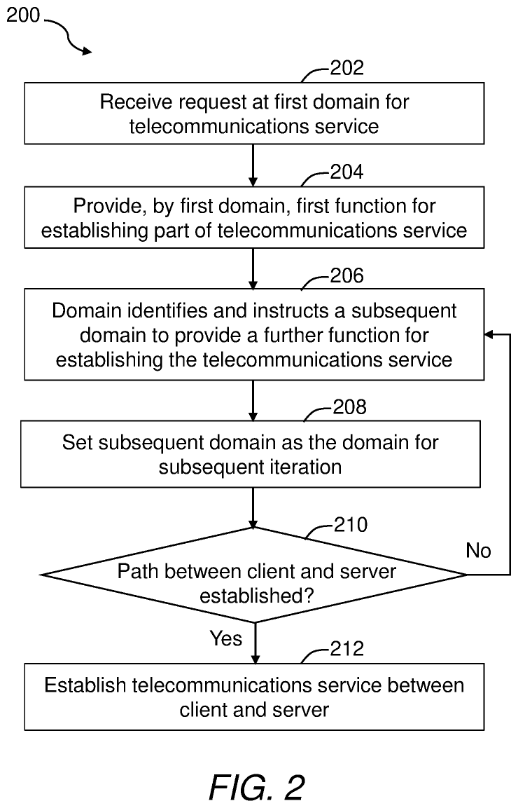

FIG. 2 is a flow diagram showing a method for establishing a telecommunications service;

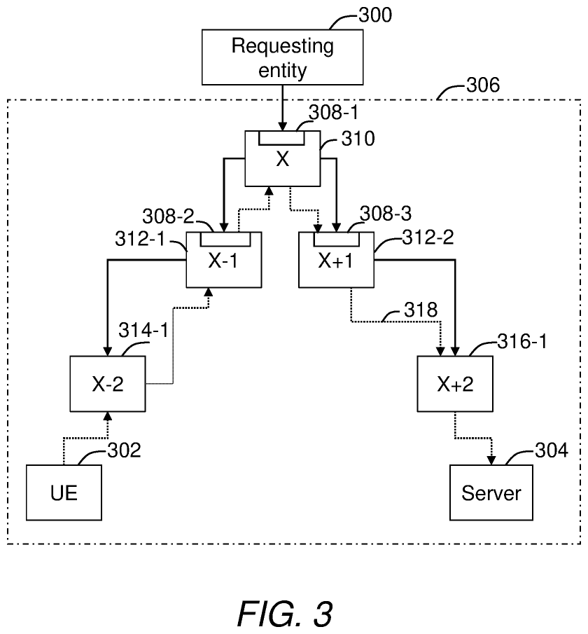

FIG. 3 is a schematic diagram showing the establishment of a telecommunications service in accordance with the method of FIG. 2;

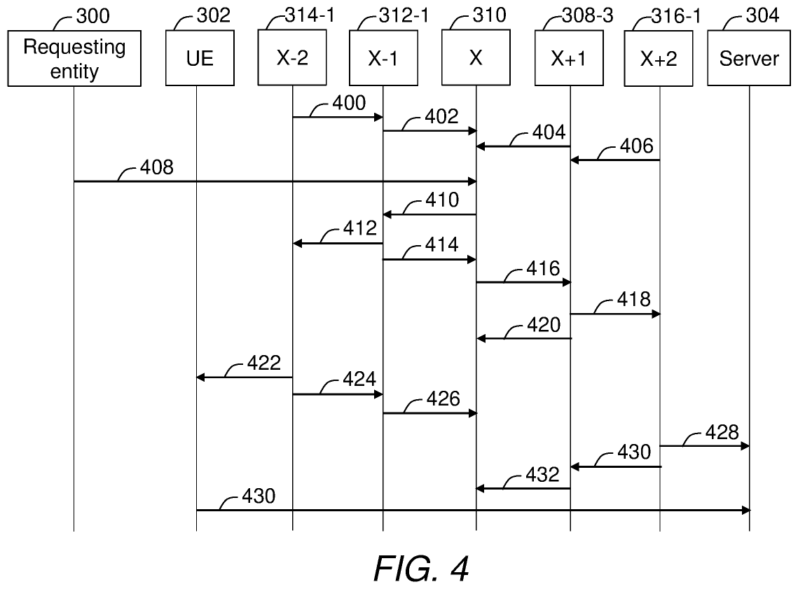

FIG. 4 is a signalling diagram showing the signalling between the components of FIG. 3;

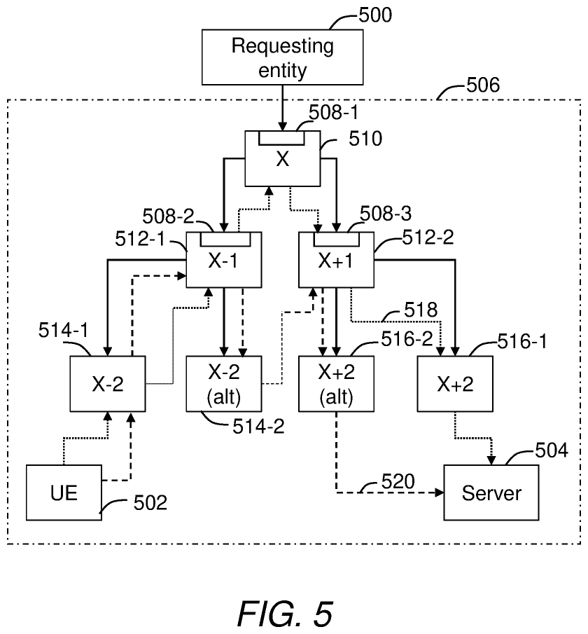

FIG. 5 is a schematic diagram showing the establishment of a telecommunications service according to a further example;

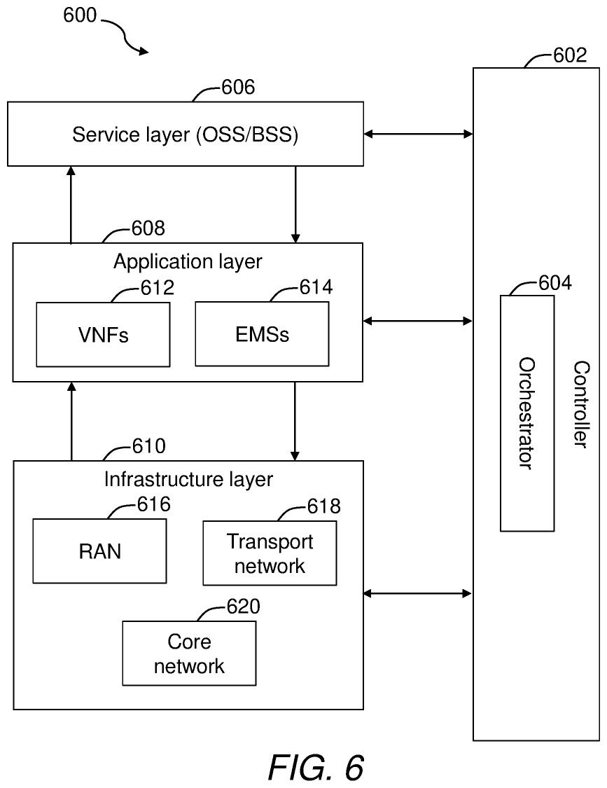

FIG. 6 is a schematic diagram showing a control framework for use with a telecommunications network; and

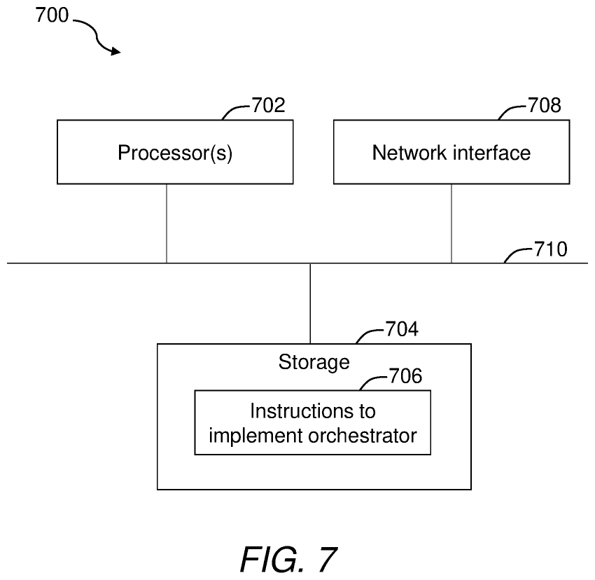

FIG. 7 is a schematic diagram showing internal components of an orchestrator.

### SPECIFIC DESCRIPTION

FIG. 1 shows an exemplary telecommunications network 100. The network 100 is a mobile cellular network comprising a plurality of User Equipment (UE) 110 (e.g. in the form of a laptop, a tablet or a mobile cellular device, sometimes referred to as a smartphone). Each UE 110 is configured to utilise the telecommunications network 100 by accessing a Radio Access Network (RAN) 115, as provided by a RAN access point 120 (e.g. in the form of a macro-, micro-, pico- or femto-cell site). In turn, the RAN access point 120 is connected to a core network 125.

The core network 125 is available to connect to remote networks and/or services 170, and not least to the Internet. As a result, the plurality of UEs 110-1 to 110-4 are also able to communicate with a UE 110-5 on a remote network 170. The UEs 110-1 to 110-4 can also communicate with a server 172 on the remote network 170.

The core network 125 in turn comprises the following functional components:
Access and Mobility management Function (AMF) 130;
Network Slice Selection Function (NSSF) 135;
AUthentication Server Function (AUSF) 140;
Unified Data Management (UDM) 145;
Session Management Function (SMF) 150;
Policy Control function (PCF) 155;
User Plane Function (UPF) 160; and
Data Network (DN) 165.

Network slicing enables multiple virtual networks dedicated to different services or service types to be created using the same underlying physical infrastructure. The virtual networks (sometimes referred to as network slices) are isolated from each other. As a result, each network slice can effectively operate as a separate and independent network function (including for providing an end-to-end network service), despite using the same physical network infrastructure. This means that each network slice can be configured for a different purpose or application in a flexible and dynamic manner. This is typically undertaken to offer differentiated service models, which might include varying performance and/or stability characteristics within a network. The NSSF 135 is configured to identify and to select a suitable network slice for UEs.

5G is envisaged to support a wide range of different use cases and services. These different services will have various different requirements, e.g. in terms of latency, throughput, connectivity and coverage. Using network slicing, an appropriate virtual network can be created for each service that satisfies the requirements for that particular service. For example, there may be a network slice for smartphones, another network slice for autonomous vehicles and a further network slice for massive Internet of Things (IoT) devices.

By means of the aforementioned functional components, the network 100 provides and manages a plurality of network slices. Network orchestration can be used to coordinate the provision and configuration of the underlying network resources, to fulfil the needs of the service(s) that will be using the network 100, e.g. to create or update a network slice. A so-called orchestrator can be provided to perform the function of network orchestration, as discussed further with reference to FIG. 3.

In FIG. 1, a telecommunications service is established between a client (in this case, a first UE 110-1) and the server 172 using at least part of the network 100. Establishing the telecommunications service in this case involves the creation of an end-to-end network slice, with the first UE 110-1 and the server 172 corresponding to respective endpoints of the network slice. By establishing the telecommunications service between the first UE 110-1 and the server 172, a resource, function, or other service can be provided to the first UE 110-1 from the server 172 across the network slice of the network 100.

An example method 200 of establishing a telecommunications service between a client and a server is shown in FIG. 2. A telecommunications service for example involves transfer of information and/or resources from the server to the client (and, in some cases, also from the client to the server). In one case, the establishment of the telecommunications service includes the creation of a network slice, as explained further with reference to FIG. 3. This is merely an example, though. Once the telecommunications service is established between the client and the server, the client can communicate with the server, e.g. to receive a resource therefrom.

At step 202 of FIG. 2, a request for the telecommunications service is received at a first domain. A domain is a physically, commercially, functionally or logically distinct portion of a network or networks, and may correspond to a particular administrative domain, such as that associated with a given entity or organisation or provided for a particular purpose; an international carrier (e.g. when roaming); a particular portion of a telecommunications network (e.g. a Radio Access Network as opposed to a core network); a regulatory isolated portion of a network (which is e.g. isolated from another portion of the network for regulatory reasons, such as security reasons); a network associated with a trusted network partner; and/or a portion of a network or networks associated with particular commercial terms. For example, a domain may be an administrative grouping of a network or networks associated with the same physical or virtual infrastructure. A domain is typically configurable separately or otherwise independently from another domain. In one case, a domain is in the form of a network associated with a network operator, a portion of a network, and/or a logical restriction for providing a service. A logical restriction for providing a service for example corresponds to a logically distinct portion of a network or networks (which may be physical or virtual networks) for use in providing the service.

A domain generally includes network elements, such as physical nodes and/or links. A domain may therefore be considered to correspond to a collection of network elements within a common sphere of management or responsibility, or a logically distinct collection of network elements. A node is a communication endpoint or an element for redistributing or otherwise transferring data, and may comprise a switch, a router, a server, and/or a storage facility. In general, a node is capable of creating, receiving and/or transmitting information to other nodes and/or network elements.

At step 204 of FIG. 2, a first function for establishing part of the telecommunications service is provided by the first domain. The first function establishes part of a path between the client and the server in order to provide, from the server, a service requested by the client. The first function is for example a function to implement the coordination or other management of the resources of the first domain to establish the part of the path to provide the service. In one case, the first function is to implement the functionality of an orchestrator, to orchestrate the first domain for providing the service. It is to be appreciated that the first function may comprise various functions or sub-functions that together allow the part of the telecommunications service to be provided. For example, the first function may comprise various low-level functions such as authentication, data validation, configuration, validation or adjustment of privacy settings, that interact together to facilitate the service being provided.

Steps 206 to 210 illustrate the repeated performance of a process until a path is established between the client and the server via a plurality of domains comprising the first domain.

At step 206 of FIG. 2, a domain identifies and instructs a subsequent domain to provide a further function for establishing the telecommunications service. Similarly, to the first function, the further function establishes a further portion of a path between the client and the server. Like the first function, the further function also implements the functionality of an orchestrator for the subsequent domain in one case. In this way, the further function implements the control of the resources of the subsequent domain to establish the further portion of the path to provide the telecommunications service. In other cases, the further function is not the same as the first function, but may act in combination with the first function to provide the path.

At step 208 of FIG. 2, the subsequent domain that was identified by the domain is set as the domain for a subsequent iteration of the process of steps 206 to 210. Step 210 involves determining whether a path between the client and the server has been established. If the path has not yet been established, steps 206 to 210 are repeated. Due to step 208, the subsequent domain that was identified and instructed by the domain in step 206 of the previous iteration is used as the domain performing the identifying and the instructing of a yet further subsequent domain in the next iteration.

The process of steps 206 to 210 is performed repeatedly until the determination at step 210 indicates that the path between the client and the server has been established. This for example occurs where the subsequent domain (which has been identified and instructed by the domain for a given iteration of the process) provides an indication to the domain for the given iteration that it is an endpoint of a network or network portion. At this point, identification of yet further subsequent domains using the subsequent domain ceases, as it can be assumed that there are no further domains beyond the subsequent domain. In this way, domains that are endpoints, which are communicatively coupled to the client or server, are identified. Once endpoint domains associated with the client and the server have both been identified, the repeated performance of the process of steps 206 to 210 ends, and the telecommunications service between the client and the server is established at step 212. The telecommunications service is provided via the plurality of domains successively identified and instructed using the repeated performance of the process of steps 206 to 210 of FIG. 2. The plurality of domains also includes the first domain. In one example, the first domain performs step 206 of FIG. 2 for the first iteration of steps 206 to 210, although this is merely an example.

With the approach of FIG. 2, each domain identifies and instructs a subsequent domain in an iterative process, until the path is established. With this approach, the first domain need not coordinate each of the domains in the path centrally. Instead, each domain can use the information it receives from other domains (which in some cases are neighbouring domains) to recursively identify and instruct these other domains with the further function to establish the telecommunications service. Hence, rather than coordinating the path centrally, e.g. using a single orchestrator, the method 200 of FIG. 2 therefore involves cascading establishment of the telecommunications service (e.g. by a process of cascaded orchestration), with each domain taking delegated responsibility for locating and choosing subsequent domains for inclusion in the path from the client to the server. This improves scalability and reduces data transfer, as it obviates the need for the information for each of the domains to be collated and processed centrally in order to identify a suitable path.

The establishment of a telecommunications service in accordance with the method 200 of FIG. 2 is shown schematically in FIG. 3.

In FIG. 3, a requesting entity 300 (e.g. a network service provider) requests the establishment of a telecommunications service between a UE 302 (an example of a client) and a server 304. In this case, the requesting entity 300 requests the provision of an end-to-end network slice 306, to provide a telecommunications service between the UE 302 and the server 304 using the network slice 306. The UE 302 and the server 304 are allocated to the network slice 306 to provide the telecommunications service from the UE 302 to the server 304.

The request is received by a first orchestrator 308-1 associated with a primary slice provider 310, which corresponds to a first domain (shown in FIG. 3 as the X domain). The first orchestrator 308-1 appropriately configures the X domain to provide the first function for establishing part of the telecommunications service. In the example of FIG. 3, the first function is for creating a subslice of the network slice 306 within the X domain. This may involve newly slicing the underlying physical infrastructure to create the network slice 306 or altering existing slicing to reconfigure the underlying physical infrastructure so as to provide the network slice 306.

The first orchestrator 308-1 also identifies two further domains for use in a path from the UE 302 to the server 304. These domains are labelled in FIG. 3 as the X−1 domain 312-1 (which may be referred to herein as the second domain), and the X+2 domain 312-2. These domains can be identified by the X domain (in this case, by the first orchestrator 308-1) in various different ways.

In FIG. 3, the X domain obtains characteristic data from X−1 and X+1 domains, which represents at least one characteristic of the X−1 and X+1 domains respectively. The X−1 and X+1 domains are identified based at least partly on the characteristic data. The characteristic data of a given domain is representative of at least one of various different characteristics of the domain, such as an availability of the domain, a location of the domain, a capacity of the domain, a connectivity of the domain and/or a performance of the domain. These characteristics may depend on or be otherwise based on other features of the domain. For example, the performance of the domain may depend on the domain expertise (e.g. the particular logical focus of the domain) and/or whether the domain is currently satisfying a given network assurance level (indicating that the performance of the domain is sufficient to meet the level of performance requested by a service provider). The capacity of the domain may depend on the current network traffic traversing the domain. The characteristic data may be obtained by the X domain prior to the X domain receiving the request for the service. For example, the X domain may periodically monitor characteristics of its neighbouring domains. This can reduce latency compared with the X domain requesting the characteristic data from the neighbouring domains after receipt of the request for the service.

The first orchestrator 308-1 uses the characteristic data, alone or in conjunction with other information such as information regarding at least one characteristic of the X domain or information based on prior use of the subsequent domain in providing a given service, in order to identify the X−1 and X+1 domains. In one case, such information includes the locations of the ingress and/or egress nodes of the X domain, e.g. with respect to the locations of connection points of the X−1 and X+1 domains, respectively. In another case, this information represents historic performance data representing a previous performance of the subsequent domain for providing the given service. For example, such performance data may represent a ratio between an amount of time the subsequent domain satisfied a given network assurance level while providing the given service and a total amount of time the subsequent domain provided the given service. In this way, the first orchestrator 308-1 can determine that the X−1 and X+1 domains are suitably located (e.g. with the X−1 and X+1 communicatively adjacent to or otherwise neighbouring the X domain) and/or are suitable (or likely to be suitable) for meeting the requirements for establishing the telecommunications service at an appropriate level of quality.

In FIG. 1, the characteristic data is obtained by the X domain for a plurality of neighbouring domains (the X−1 and X+1 domains in this case). The X domain then selects suitable domains for the path from the neighbouring domains. In FIG. 3, both the X−1 and X+1 domains are identified as being suitable for establishing the telecommunications service. Both of these domains are therefore instructed by the X domain to provide a further function for establishing the telecommunications service. The instructing of the X−1 and X+1 domains to provide the further function is performed by the first orchestrator 308-1, which instructs orchestrators 308-2, 308-3 associated with the X−1 and X+1 domains, respectively, to provide the further function. As the X−1 domain may be referred to as the second domain, the further function that the X domain instructs the X−1 domain to provide may be referred to as a second function.

In FIG. 3, the further function is for creating a further subslice of the network slice 306 within the subsequent domain. As both the X−1 and X+1 domain are instructed to provide the further function, this therefore causes the creation of further subslices of the network slice 306 within both the X−1 and X+1 domains, respectively.

The instructing of the X−1 and X+1 domains by the X domain also includes the X domain instructing the X−1 and X+1 domains to themselves identify and instruct at least one further subsequent domain to provide the further function for establishing the telecommunications service. This process is repeated recursively, until a path between the UE 302 and the server 304 has been established. In this way, the X domain identifies and instructs the X−1 and X+1 domains to identify and instruct the at least one further subsequent domain without the X domain directly communicating with the at least one further subsequent domain. The responsibility to identify and instruct the at least one further subsequent domain has thereby been delegated from the X domain to the X−1 and X+1 domains.

The X−1 domain identifies a subsequent domain (the X−2 domain 314-1). The X−2 domain may be referred to herein as a third domain, and the further function that the X−1 domain instructs the X−2 domain to provide may be referred to herein as a third function. The identifying of respective domains is shown schematically in FIG. 3 with solid lines between respective domains, and for example includes performing an application programming interface (API) call to orchestrators associated with domains neighbouring a given domain that is performing the identifying. In FIG. 3, each domain performs an API call to orchestrators associated with each neighbouring domain (including other domains not shown in FIG. 3), to identify at least one of the neighbouring domains for use in establishing the telecommunications service.

It is to be appreciated that the identifying and instructing of each of the domains in FIG. 3 is performed by respective orchestrators associated with each domain. However, for ease of illustration, only the orchestrators 308-1, 308-2, 308-3 associated with the X, X−1 and X+1 domains are shown in FIG. 3. Each of the other domains of FIG. 3 nevertheless comprises a respective orchestrator (not shown in FIG. 3).

In FIG. 3, each of the domains includes a suitable interface, which in this case is an application programming interface (API), not shown in FIG. 3, to transmit and receive instructions to provide any of the functionality described herein (e.g. to provide the first and/or further functions). The API of each domain may be considered to be an exposed orchestration API of each orchestrator. Each of the APIs is associated with a respective orchestrator of a given domain, as discussed further with reference to FIG. 6.

The X−2 domain is an endpoint domain, which is in communication with the UE 302. Hence, it is determined that seeking of further domains beyond the X−2 domain is not required, as using the X−2 domain as an endpoint domain provides for a path from the UE 302 to the server 304. The X−2 domain therefore does not identify or instruct further domains for providing the telecommunications service.

A similar cascading approach to identifying and instructing domains to establish the path from the UE 302 to the server 304 is performed by the X+1 domain, which identifies the X+2 domain 316-1. The X+2 domain is identified as corresponding to a further endpoint domain, which is in communication with the server 304, so no further seeking of domains beyond the X+2 domain is performed.

After identifying and instructing the domains in this recursive manner, the telecommunications service between the UE 302 and the server 304 is established. This allows communication between the UE 302 and the server 304 via a path 318, which is shown in FIG. 3 with a dotted line. As can be seen from FIG. 3, the path 318 from the UE 302 to the server 304 passes from the UE 302, to the X−2 domain, to the X−1 domain, to the X domain, to the X+1 domain, to the X+2 domain, to the server 304. By identifying and instructing the domains as shown in FIG. 3, the network slice 306 is created in a more scalable and/or signalling- and processing-efficient manner than otherwise, providing for communication between UE 302 and the server 304 via the network slice 306.

In FIG. 3, the domains are identified and instructed by respective orchestrators without a centralised orchestrator (e.g. the orchestrator of the X domain) coordinating this identification and instruction process. This approach therefore obviates the need for a centralised orchestrator to maintain knowledge of each of a plurality of subsequent domains or to control or otherwise coordinate these subsequent domains. Instead, the coordination and control is distributed across the plurality of domains. Each domain takes delegated responsibility for locating and choosing subsequent domains (in this case, neighbouring domains) for use in the path 318 between the UE 302 and the server 304. This removes a central point of weakness from the system, meaning that this approach is more robust than otherwise. Moreover, the amount of information transferred and processed is reduced compared to other approaches in which a centralised orchestrator manages orchestration across each of the other domains. This approach is hence more scalable.

The signalling between the components shown in FIG. 3 is shown schematically in FIG. 4. At step 400, the X−2 domain sends a status signal to the X−1 domain indicating a status of the X−2 domain. A status of a given domain for example indicates a state or condition of the given domain, which e.g. may indicate the capability of the given domain for use in establishing the telecommunications service. The status signal at step 400 indicates that the X−2 domain is available for use in establishing a telecommunications service, and may include or otherwise represent characteristic data as described with reference to FIG. 3. The X−1 domain sends a similar status signal to the X domain at step 402, the X+1 domain sends a similar status signal to the X domain at step 404 and the X+2 domain sends a similar status signal to the X+1 domain at step 406. By communicating in this way, each of the domains is aware of a current status of neighbouring domains. This status information can be used during the identification and instruction of subsequent domains by each domain.

At step 408, the requesting entity 300 requests a service from the X domain. In this case, the service requested by the requesting entity 300 is the establishment of a given network slice for establishing a telecommunications service between the UE 302 and the server 304. However, this is merely an example.

In response to this request, the X domain identifies the X−1 and X+1 domains for establishing the telecommunications service, as discussed further with reference to FIG. 3. At step 410, the X domain instructs the X−1 domain to provide the further function for establishing the telecommunications service. This for example involves creating a delegated orchestration task for the orchestrator of the X−1 domain. At step 412, the X−1 domain instructs the X−2 domain to provide the further function. At step 414, the X−1 domain communicates with the X domain to indicate that the X−1 domain has provided the further function and that the X−2 domain has been identified and instructed to provide the further function. In other cases, though, these indications may be provided separately.

The X domain communicates with the X+1 domain in a similar manner. At step 416, the X domain instructs the X+1 domain to provide the further function and at step 418, the X+1 domain instructs the X+2 domain to provide the further function. At step 420, the X+1 domain communicates with the X domain to indicate that the X+1 domain has provided the further function and that the X+2 domain has been identified and instructed to provide the further function.

The X−2 domain is the access network for the UE 302. Hence, at step 422, the X−2 domain communicates with the UE 302 so as to connect the UE 302 to the X−2 domain. The X+2 domain is the network domain that can access an application, which is hosted by the server 304, which may be a cloud server, for example. At step 428, the X+2 domain communicates with the server 304 so as to connect the server 304 to the X+2 domain. At steps 424 and 430, the X−2 and the X+2 domains communicate with the X−1 and X+1 domains respectively, to indicate that the UE 302 and the server 304 are connected to the X−2 and X+2 domains. At steps 426 and 432, the X−1 and the X+1 domains respectively communicate with the X domain, to indicate that the UE 302 and the server 304 are connected to the X−2 and X+2 domains (via the X−1 and X+1 domains, respectively).

At step 430, the UE 302 communicates with the server 304 via the path established via the X−2, X−1, X, X+1 and X+2 domains. In this way, the UE 302 can access the network slice and communicate with the server 304, in this case to access the application hosted by the server 304. The telecommunications service between the UE 302 and the server 304 is thereby established.

FIG. 5 shows schematically a further example of the establishment of a telecommunications service. FIG. 5 is the same as FIG. 3, except that it shows the establishment of an alternative path 520, which can be used instead of the path 318 of FIG. 3. Features of FIG. 5 that are the same as those of FIG. 3 are labelled with the same reference numerals, but incremented by 200; corresponding descriptions are to be taken to apply.

In FIG. 5, the X−1 domain 512-1 identifies two neighbouring domains: the X−2 domain 514-1 and the X−2 (alt) domain 514-2. However, the X−1 domain initially determines that the X−2 (alt) domain is unsuitable for establishing the telecommunications service. On this basis, the X−2 (alt) domain is not instructed with the further function. Instead, solely the X−2 domain is instructed with the further function to establish the telecommunications service.

The determination that the X−2 (alt) domain is unsuitable is based on monitoring of a status of the X−2 and X−2 (alt) domain by the X−1 domain, as discussed further below. This determination may additionally or alternatively be based on other characteristics of the X−2 (alt) domain, e.g. indicating that the physical resources associated with the X−2 (alt) domain are located geographically further from those of the X−1 domain than the X−2 domain. Characteristic data representing these characteristics may be communicated from the X−2 (alt) domain to the X−1 domain, so that the X−1 domain can identify a suitable domain to use in the path. For example, such characteristic data may be sent between various pairs of neighbouring domains and in some cases between each domain and its neighbouring domains.

The X+1 domain 512-2 of FIG. 5 also identifies two neighbouring domains: the X+2 domain 516-1 and the X+2 (alt) domain 516-2. The X+1 domain initially identifies that the X+2 (alt) domain is unsuitable for the establishment of the telecommunications service, so the X+2 (alt) domain is not used in the path 518 between the UE 502 and the server 504. The X+2 (alt) domain is also not instructed with the further function at this time.

The path 518 between the UE 502 and the server 504 is then established, via the X−2 domain, the X−1 domain, the X domain 510, the X+1 domain and the X+2 domain. The X−2 (alt) and the X+2 (alt) domains are not used in the path 518, because it has been determined by the orchestrators 508 of each of the domains that a suitable path between the UE 502 and the server 504 bypasses the X−2 (alt) and X+2 (alt) domains.

However, in the example of FIG. 5, the path between the UE 302 and the server 304 changes dynamically. For example, at least one of the domains may be removed from the path, and a different domain may be used instead. In this way, the plurality of domains of the path is updated over time, increasing the resilience of the system to unexpected events such as loss of connectivity or unexpectedly high load for one or more of the domains. In FIG. 5, if one of the domains of the path 518 becomes unavailable or unsuitable for establishing the telecommunications service, the alternative path 520 is used to provide the telecommunications service instead.

In FIG. 5, a first one of a plurality of the domains of the initial path 518 (the X−1 domain in this case) monitors a status of a second one of the plurality of domains (the X domain in this case) neighbouring the first one of the plurality of domains. The X−1 domain also monitors a status of at least one further domain that neighbours the X−1 domain (the X−2 (alt) domain). The at least one further domain does not form part of the path 518 via which the telecommunications service between the UE 502 and the server 504 is established initially.

After the path 518 is established, the X−1 domain determines that the X domain is now unsuitable for providing the telecommunications service, based on the status of the X domain. For example, the status may indicate that the X domain is unavailable and/or that a capacity of the X domain fails to satisfy a capacity condition. For example, if the X domain is offline or is suffering from particularly high traffic (e.g. that is higher than the traffic within other domains), the X domain may be considered unsuitable for the telecommunications service. The status of a given domain is monitored by an orchestrator 508 of a neighbouring domain in the example of FIG. 5 (although this is not intended to be limiting). As for FIG. 3, only three orchestrators 508 are shown in FIG. 5, but it is to be appreciated that each domain may include a respective orchestrator.

The X−1 domain identifies an alternative domain (in this case, the X−2 (alt) domain) to the X domain. This identification is performed by the orchestrator 508-2 of the X−1 domain in FIG. 5, but this is merely an example. The X−2 (alt) domain is identified based on the status of the X−2 (alt) domain. For example, by comparing the status of the X and the X−2 (alt) domains, the X−1 domain can identify that the X−2 (alt) domain is more suitable for use in the path, e.g. because data can be transferred more rapidly via the path 520 including the X−2 (alt) domain than the path 518 including the X domain. The identification of the X−2 (alt) domain may additionally be based on characteristic data associated with the X−2 (alt) domain, the X domain and/or the X−1 domain itself. The plurality of domains is then updated to include the X−2 (alt) domain instead of the X domain. This for example includes the X−1 domain instructing the newly-identified X−2 (alt) domain to provide the further function and to identify a subsequent domain for establishing the telecommunications service, and so on. The X−1 domain may additionally communicate with the X domain, to configure the X domain such that the X domain is excluded from the plurality of domains.

The inclusion of the X−2 (alt) domain in the plurality of domains instead of the X domain is communicated to a subsequent domain (the X+1 domain in this case) by the X−2 (alt) domain (and so on for domains subsequent to the X+1 domain). In this way, updates to a path for establishing the telecommunications service are also established on a domain-by-domain basis, rather than being managed and/or communicated centrally.

The X+1 domain in this example was already previously instructed to provide the further function by the X domain (due to its previous inclusion in the initial path 518). However, the X−2 (alt) domain configures the X+1 domain suitably to establish the telecommunications service via the X−2 (alt) domain and the X+1 domain. It is to be appreciated that this may include the X+1 domain being instructed to provide the further function by the X−2 (alt) domain or the X+1 domain being otherwise suitably configured for use in the alternative path 520 that includes the X−2 (alt) domain.

The X+1 domain monitors a status of a neighbouring domain (the X+2 domain) that forms part of the plurality of domains of the initial path 518, as well as a further domain (the X+2 (alt)) domain) that is not part of the initial path 518. After the initial path 518 is established, the X+1 domain determines that the X+2 domain is no longer suitable for establishing the telecommunications service. On the basis of this determination, the X+2 domain is removed from the plurality of domains and replaced by the X+2 (alt) domain. By updating the plurality of domains in this way, the path for establishing the telecommunications service is also updated from the initial path 518 (via the X−2, X−1, X, X+1, and X+2 domains) to the alternative path 520 (via the X−2, X−1, X−2 (alt), X+1, and X+2 (alt) domains).

This approach may be performed repeatedly, to dynamically update the path for the telecommunications service. In this way, the telecommunications service is established more resiliently, with reduced susceptibility to outages or reductions in service associated with individual domains.

FIG. 6 is a schematic diagram showing a control framework 600 for use with the telecommunications network, such as the network 100 of FIG. 1. The control framework 600 can be used to establish a telecommunications service between a client and a server as described with reference to FIGS. 2 to 5. The control framework 600 has been simplified for ease of illustration: it is to be appreciated that control frameworks such as that of FIG. 6 may include additional components not shown in FIG. 6.

The control framework 600 includes a controller 602, which includes an orchestrator 604. The orchestrator 604 may be used to implement the methods described herein. An example of internal components of an orchestrator is shown schematically in FIG. 7.

The control framework includes three layers: a service layer 606, an application layer 608 and an infrastructure layer 610. The service layer 606 interfaces with network entities that share an underlying physical network, such as an operational support system (OSS) or business support system (BSS) of a given telecommunications service provider. The service layer 606 is shown as separate from the orchestrator 604 in FIG. 6, but in other cases, the service layer 606 may form part of the orchestrator 604 itself. The service layer 606 manages service requirements and sends requests to the orchestrator 604, to manage a requested service. In one case, the request to establish the telecommunications service discussed with reference to FIG. 3 is sent from the service layer 600 of a requesting entity to the orchestrator 604, which in this case is an orchestrator of the first domain. Such requests are typically sent to the orchestrator 604 via a suitable interface, such as an API, not shown in FIG. 6.

The service layer 606 communications with the application layer 608. The application layer 608 (which may be referred to as a network function layer) comprises a set of network functions to implement various predefined behaviours and interfaces. In FIG. 6, the application layer 608 includes virtualized network functions (VNFs) 612 and element management systems (EMSs) 614. A VNF 612 for example includes various virtual machines implementing various different processes. An EMS 614 is responsible for the functional management of a VNF. The application layer 608 can be instructed to create a network slice by the orchestrator 604, e.g. if the request from the service layer 606 is a request to create a network slice.

The application layer 608 communicates with the infrastructure layer 610. The infrastructure layer 610 represents the underlying physical infrastructure. The infrastructure layer 610 can be configured by the application layer 608 to allocate respective portions of the physical infrastructure to specific applications, e.g. to implement the network slice. In FIG. 6, the infrastructure layer 610 includes a RAN 616, a transport network 618 and a core network 620, but this is merely an example.

The controller 602 (include the orchestrator 604) interfaces with the service, application and infrastructure layers 606, 608, 610 to coherently manage the provision of the requested service. In this way, the controller 602 flexibly manages the underlying resources so as to provide the requested service.

In a network 100 such as that of FIG. 1 or a network slice 306, 506 such as those of FIGS. 3 and 5, each domain of a plurality of domains may respectively include a control framework 600 such as that of FIG. 6, so as to provide a telecommunications service. In such cases, a southbound API of an orchestrator of a control framework of a given domain may communicate with a northbound API of an orchestrator of a control framework of a subsequent domain. Each orchestrator 604 of the a respective control framework 600 in such cases may be configured to identify and instruct an orchestrator of a subsequent domain to provide a function for establishing a telecommunications service, as explained further with reference to FIGS. 2 to 5.

FIG. 7 is a schematic diagram showing internal components of an orchestrator 700, which may be used in the implementation of the methods herein. It is to be appreciated that components of the orchestrator 700 may be comprised by a single device or may be distributed across a plurality of separate devices, e.g. to form a distributed system.

The orchestrator 700 includes at least one processor 702 (which may be or comprise processor circuitry). The at least one processor 702 is arranged to execute program instructions and process data. The at least one processor may include a plurality of processing units operably connected to one another, including but not limited to a central processing unit (CPU) and/or a graphics processing unit (GPU).

The orchestrator 700 also includes storage 704, which may be or include volatile or non-volatile memory, read-only memory (ROM), or random access memory (RAM). The storage 704 may additionally or alternatively include a storage device, which may be removable from or integrated within the orchestrator 700. For example, the storage 704 may include a hard disk drive (which may be an external hard disk drive such as a solid state disk) or a flash drive. The storage 704 is arranged to store data, temporarily or indefinitely. The storage 704 may be referred to as memory, which is to be understood to refer to a single memory or multiple memories operably connected to one another. The storage 704 of the orchestrator 700 may be storage of a single physical device or may instead be distributed across a physical network to improve resilience.

The storage 704 may be or include a non-transitory computer-readable medium. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

In FIG. 7, the storage 704 includes instructions 706 to implement the functionality of the orchestrator when processed by the at least one processor 702. Although not shown in FIG. 7, it is to be appreciated that the storage 704 is typically arranged to store further data than the instructions 706, such as the characteristic data discussed herein, or other data to be processed by the orchestrator 700 to implement the functionality of the orchestrator. In other cases, though, the characteristic data may be stored by storage external to the orchestrator 700. In such cases, the external storage is generally nevertheless accessible to the orchestrator 700, or the orchestrator 700 is configured to receive the characteristic data from the external storage, so that the orchestrator 700 can process the characteristic data as needed.

The orchestrator 700 includes a network interface 708 for connecting the orchestrator 700 to a network, such as the network of the domain with which the orchestrator 700 is associated. The components of the orchestrator 700 are interconnected via a system bus 710.

### Alternatives and Modifications

In the aforementioned, the telecommunications network 100 is generally shown and described as a cellular wide area network in accordance with 5G technology. However, in one alternative the telecommunications network 100 is any kind of telecommunications network, including a wired network, a local area network, or combination of network types (e.g. a HetNet).

In FIG. 1, the UEs 110 are shown as accessing the same core network. However, it will be appreciated that the UEs can access different core networks (and be connected to one another via the remote network 170).

The server 172 forms part of the remote networks and/or services 170 in FIG. 1. However, in other cases, the server may form part of or be associated with a different network and/or service, such as the core network 125.

In FIGS. 3 and 4, the first and further functions are to create respective subslices of a given network slice, so as to create an end-to-end network slice for end-to-end communication between a client and a server. This is merely an example, though, and in other cases, the first and further functions are to provide a different service than for creation of a network slice, which nevertheless allow a telecommunications network to be established between the client and the server. For example, the first and further functions may be to create a telecommunications network across different territories, e.g. between a client in one territory and a server in a different territory. In this way, the concepts herein can be used to create a multi-national private network, for example.

In FIGS. 3 and 4, some of the domains identify and instruct a plurality of subsequent domains to provide the service. However, in other examples, each domain may identify and instruct a single subsequent domain, or each domain may identify and instruct a plurality of subsequent domains.

In FIGS. 3 and 4, orchestrators associated with respective domains identify and instruct subsequent domains to provide a further function for establishing a telecommunications service. In other cases, a different component than an orchestrator may perform similar functionality. For example, a computer system that includes similar features to the orchestrator 700 illustrated in FIG. 7 may implement this functionality. Such a computer system may be a more generalised computer system than an orchestrator, and may be a distributed computer system. In general, the methods described herein may be performed by at least one processor of a telecommunications network, which may form part of an orchestrator system and/or a computer system.

In FIGS. 3 to 5, the client is a UE and the server hosts an application. In other examples, though, the client may be a different element and/or the server may host a different element than an application.

In examples such as that of FIGS. 3 and 4, characteristic data is used to identify domains to be instructed to provide the further function. In other cases, a given domain may use a status of other domains in addition to or instead of the characteristic data to identify a subsequent domain to be instructed to provide the further function.

FIG. 5 illustrates an example in which the X−1 and X+1 domains each monitor a status of each of their neighbouring domains. However, this need not be the case in other examples. In other cases, the decision to use an alternative domain in a path may instead be based on determining that a given domain of a path is unsuitable, and selecting the alternative domain based on another characteristic of the alternative domain than its status, e.g. its location compared to the domain doing the determining, or based on a lack of other available domains (e.g. if there is only a single alternative domain for the path). It is to be appreciated that, in some cases, each domain (or a subset of domains) of a path may monitor the status of at least one neighbouring domain, e.g. to identify an alternative domain for use in the path if one of the domains of the path becomes unsuitable.

Each feature disclosed herein, and (where appropriate) as part of the claims and drawings may be provided independently or in any appropriate combination.

Any reference numerals appearing in the claims are for illustration only and shall not limit the scope of the claims.

Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The methods and processes described herein can be partially or fully embodied in software or partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, network personal computers (PCs), minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

1. A method of establishing a telecommunications service between a client and a server, the method comprising:
receiving a request at a first domain for the telecommunications service;
providing, by the first domain, a first function for establishing part of the telecommunications service;
repeatedly performing a process until a path is established between the client and the server via a plurality of domains comprising the first domain, the process comprising:
a domain identifying and instructing a subsequent domain to provide a further function for establishing the telecommunications service; and
using the subsequent domain as the domain for a subsequent iteration of the process; and
establishing the telecommunications service between the client and server via the plurality of domains.

2. The method according to claim 1, wherein the first function is for creating a subslice of a given network slice within the first domain, and the further function is for creating a further subslice of the given network slice within the subsequent domain.

3. The method according to claim 1, wherein the plurality of domains comprises the first domain, a second domain and a third domain, the second domain having been identified and instructed by the first domain to provide the further function, and the third domain having been identified and instructed by the second domain to provide the further function.

4. The method according to claim 3, comprising the second domain communicating to the first domain that the third domain has been identified and instructed by the second domain to provide the further function.

5. The method according to claim 1, wherein each respective domain in the plurality of domains comprises an orchestrator, and wherein the identifying and instructing is performed by each orchestrator.

6. The method according to claim 1, wherein at least one performance of the process comprises the domain identifying and instructing a plurality of subsequent domains to provide the further function.

7. The method according to claim 1, wherein the domain identifying the subsequent domain comprises the domain identifying a neighbouring domain as the subsequent domain.

8. The method according to claim 1, comprising:
a first one of the plurality of domains monitoring a status of a second one of the plurality of domains that neighbours the first one of the plurality of domains;
based on the status of the second one of the plurality of domains, determining that the second one of the plurality of domains is unsuitable for providing the telecommunications service;
the first one of the plurality of domains identifying an alternative domain to the second one of the plurality of domains for providing the telecommunications service; and
updating the plurality of domains to include the alternative domain instead of the second one of the plurality of domains.

9. The method according to claim 8, wherein the first one of the plurality of domains monitors a status of at least one further domain that neighbours the first one of the plurality of domains, and identifying the alternative domain comprises identifying the alternative domain from the at least one further domain based on the status of the alternative domain.

10. The method according to claim 1, comprising:
each respective domain of the plurality of domains monitoring a status of at least one neighbouring domain of the plurality of domains; and
based on the status of at least one of the plurality of domains, updating the plurality of domains to include a different at least one domain instead of the at least one of the plurality of domains.

11. The method according to claim 10, wherein the status indicates that the at least one of the plurality of domains is unavailable and/or that a capacity of the at least one of the plurality of domains fails to satisfy a capacity condition.

12. The method according to claim 1, wherein the process comprises the domain obtaining characteristic data from the subsequent domain, the characteristic data representative of at least one characteristic of the subsequent domain, wherein the identifying the subsequent domain is based at least partly on the characteristic data.

13. The method according to claim 12, wherein the characteristic data is representative of an availability of the subsequent domain, a location of the subsequent domain, a capacity of the subsequent domain, a connectivity of the subsequent domain and/or a performance of the subsequent domain.

14. The method according to claim 1, wherein a given domain of the plurality of domains is in the form of: a network associated with a network operator; a portion of a network; and/or a logical restriction for providing a service.

15. The method according to claim 1, wherein the client comprises User Equipment (UE).

16. A telecommunications network for establishing a telecommunications service between a client and a server, the telecommunications network comprising at least one processor configured to:
receive a request at a first domain of the telecommunications network for the telecommunications service;
provide, by the first domain, a first function for establishing part of the telecommunications service;
repeatedly perform a process until a path is established between the client and the server via a plurality of domains comprising the first domain, the process comprising:
a domain identifying and instructing a subsequent domain to provide a further function for establishing the telecommunications service; and
using the subsequent domain as the domain for a subsequent iteration of the process; and
establish the telecommunications service between the client and server via the plurality of domains.

17. The telecommunications network according to claim 16, wherein each respective domain in the plurality of domains comprises an orchestrator comprising at least one of the at least one processor, and wherein the identifying and instructing is performed by each orchestrator.

18. The telecommunications network according to claim 16, wherein each respective domain in the plurality of domains comprises an application programming interface to transmit and/or receive instructions to provide the further function.

19. The telecommunications network according to claim 16, wherein each respective domain in the plurality of domains comprises storage for storing characteristic data representative of at least one characteristic of at least one neighbouring domain of the plurality of domains.

20. A method of establishing a telecommunications service between a client and a server, the method comprising:
receiving a request at a first domain for the telecommunications service;
providing, by the first domain, a first function for establishing the telecommunications service;
the first domain identifying and instructing a second domain to provide a second function for establishing the telecommunications service;
the second domain identifying and instructing a third domain to provide a third function for establishing the telecommunications service; and
establishing a path between the client and the server via the plurality of domains, the plurality of domains comprising the first domain, the second domain and the third domain.

21. The method according to claim 20, comprising the first domain identifying and instructing the second domain to identify and instruct the third domain to provide the third function.

22. The method according to claim 20, wherein the first domain identifies and instructs the second domain to identify and instruct the third domain without the first domain directly communicating with the third domain.

23. The method according to claim 20, wherein the second domain identifying and instructing the third domain to provide the third function comprises the second domain identifying and instructing a plurality of domains, comprising the third domain, to provide the third function.

24. The method according to claim 20, wherein the third domain is adjacent to the second domain and the method comprises:
the second domain monitoring a status of the third domain;
based on the status of the third domain, determining that the third domain is unsuitable for providing the telecommunications service;
identifying an alternative domain to the third domain for providing the telecommunications service; and
replacing the third domain with the alternative domain in the path.

25. A computer-readable medium storing thereon a program for carrying out the method of claim 1.
